(19) United States
(12) Patent Application Publication
(10) Pub. No.: US 2025/0345801 A1
(43) Pub. Date: Nov. 13, 2025

(54) Stackable Tube Rack

(71) Applicant: Foundation Medicine, Inc., Cambridge, MA (US)

(72) Inventors: Megan Yiyi Uozumi, San Diego, CA (US); Charles Warren, East Boston, MA (US)

(21) Appl. No.: 19/201,785

(22) Filed: May 7, 2025

Related U.S. Application Data
(60) Provisional application No. 63/643,837, filed on May 7, 2024.

(51) Int. Cl. B01L 9/06

(52) U.S. Cl. CPC B01L 9/06; B01L 2200/025; B01L 2200/028; B01L 2200/087; B01L 2300/042

(57) ABSTRACT

A tube rack has a base defining base holes configured to hold inserted tubes, such as tubes that store biological samples of subjects. The tube rack also has a lid that may be positioned above the base, such that tops of the inserted tubes are positioned within a gap between the base and the lid. The tube rack may be stackable, such one tube rack holding one set of tubes may be stacked on the lid of a different tube rack that holds a different set of tubes. Multiple stacked tube racks may fit within an outer container, such as a cooler or shipping container.

### CROSS-REFERENCE TO RELATED APPLICATIONS

This application claims priority to U.S. Provisional App. No. 63/643,837, filed on May 7, 2024, which is incorporated by reference herein in its entirety.

### BACKGROUND

Many individuals rely on genetic testing and/or other diagnostic tests to identify whether they have, or are predicted to develop, various health related conditions. Genetic testing may also indicate which types of treatments may be most effective for particular individuals and/or particular conditions. For example, blood samples, saliva sample, and/or other types of biological samples may be collected from patients or other subjects. Diagnostic tests, DNA sequencing, and/or other operations may be performed using such biological samples.

In many cases, biological samples may be collected from subjects at first locations, such as clinician offices, hospitals, clinical trial locations, or other locations. The biological samples may also be transported to second locations, such as laboratories or other different locations, where the biological samples may be processed and/or tested.

For example, collected saliva samples may be stored and/or transported in tubes. At a laboratory, the samples may be processed by manipulating the tubes. For instance, lysis operations may performed on the saliva samples that are or were held in the tubes, to extract and/or purify DNA, so that the DNA may be sequenced, amplified, and/or otherwise processed.

### BRIEF DESCRIPTION OF THE DRAWINGS

Various aspects of the disclosed methods, devices, and systems are set forth with particularity in the appended claims. A better understanding of the features and advantages of the disclosed methods, devices, and systems will be obtained by reference to the following detailed description of illustrative embodiments and the accompanying drawings, of which:

FIG. 1 illustrates an example of a tube rack configured to hold a set of tubes.

FIG. 2 shows an angled top view of the tube rack in a disconnected configuration in which the lid is disconnected from the base.

FIG. 3 shows an example in which the lid may slide into place above the base, to place the tube rack in a connected configuration.

FIG. 4 shows an example in which the tube rack is a connected configuration.

FIG. 5 shows an example of stacked tubes racks that hold respective sets of tubes.

FIG. 6 shows an example in which stacked tube racks are within an outer container.

FIG. 7 shows an example of a process for stacking tube racks during storage and/or transport of biological samples.

### DETAILED DESCRIPTION

Various implementations of the present disclosure relate to a tube rack that may store tubes, such as tubes containing biological samples. For example, tubes containing saliva samples, blood samples, or other biological samples associated with patients or other subjects may be inserted into the tube rack for storage and/or transport.

In some situations, tubes containing biological samples may be inserted into tube racks and/or other containers for storage and/or transport. As an example, Styrofoam tube mailers may have cutouts that allow tubes to be placed horizontally during storage and/or transport. As another example, tube racks made of foam, metal, and/or other materials may have receptacles that allow a tubes to be placed vertically during storage and/or transport.

Such tube racks or tube containers may, in some cases, be stored or transported directly, or may be placed into an outer container during storage and/or transport. As an example, a tube rack holding a set of tubes may be placed into a box or other shipping container, so that the tube rack may be transported to a laboratory or another location. As another example, a tube rack holding tubes containing temperature-sensitive biological samples may be placed into an insulated cooler or insulated shipping container to keep the biological samples cool, or to otherwise control temperatures of the biological samples, during storage and/or transport.

However, many existing solutions may limit the number of tubes that may be stored and/or transported together. For instance, many existing tube racks are not stackable, and thus may not be stacked within a cooler or other outer container during storage or transport. Such existing tube racks may accordingly limit the number of tube racks, and thus the overall number of tubes, that may fit into an outer container for storage and/or transport.

For example, some tube racks provide a grid of walls that define receptacles for tubes. However, when tubes are inserted into such a grid-based tube rack, top portions of the tubes may extend above the walls of the tube rack. Accordingly, there may be no surface above the tops of the tubes and/or the tube rack that would be able to support a second tube rack stacked above the tube rack.

Accordingly, users may be limited to storing and/or transporting one individual tube rack in each individual outer container, such as an insulated cooler or shipping box. For instance, if two grid-based tube racks are each capable of holding twenty-four tubes, a first set of twenty-four tubes may be inserted into a first grid-based tube rack, and a second set of twenty-four tubes may be inserted into a second grid-based tube rack. A user may place the first grid-based tube rack into a first outer container for storage and/or transport. Sufficient space may exist above the first grid-based tube rack to potentially fit the second grid-based tube rack within the first outer container. However, because the first grid-based tube rack may lack a surface that could support the second grid-based tube rack above the first grid-based tube rack, the user may avoid placing the second grid-based tube rack into the first outer container, and may instead place the second grid-based tube rack into a different second outer container for storage and/or transport.

As such, existing tube racks that are not designed to be stackable may lead to an inefficient use of space within outer containers and/or during storage of tube racks. Similarly, existing tube racks that are not designed to be stackable may lead to usage of an increased number of outer containers, and thereby lead to an increase in shipping costs and/or increased usage of space to store and/or transport the outer containers.

The tube rack described herein may address these and other concerns. For example, the tube rack may include a base and a lid that covers tops of tubes held within the base. The lid of the tube rack may be configured to support a base of a different tube rack and/or bottoms of tubes held within the different tube rack. Accordingly, multiple tube racks holding different sets of tubes may be stacked. Two or more stacked tube racks may fit into an outer container, such as an insulated cooler or shipping container. As such, the use of multiple stacked tube racks may increase the overall number of tubes that may be stored and/or transported within the outer container, relative to a number of tubes that could be held by one non-stackable tube rack that may otherwise fit into the outer container. The stackable tube rack described herein may accordingly lead to a more efficient use of space, reduced shipping costs, and/or other benefits relative to other types of tube racks.

### Example Definitions

As used herein, the terms “deoxyribonucleic acid,” “DNA,” “DNA molecule,” and their equivalents, may refer to a polymer of nucleotides (also referred to as “nucleobases”) containing deoxyribose. The nucleotides in DNA include cytosine (C), guanine (G), adenine (A), and thymine (T). Each DNA nucleotide includes a deoxyribose and a phosphate group. An example single-stranded DNA (ssDNA) molecule includes a chain of covalently bonded DNA nucleotides. In the example ssDNA molecule, the phosphate group of the mth nucleotide is covalently bonded to the deoxyribose of the (m−1)th nucleotide, wherein m is a positive integer greater than 2 and less than or equal to the number of DNA nucleotides in the chain. In various examples, DNA is double-stranded and includes two ssDNA molecules that are complementary to one another and coiled around each other in a double helix form. The nucleotides of one ssDNA molecule are hydrogen bonded to the nucleotides of the other ssDNA molecule. In particular, the pyrimidines (A and T) hydrogen bond to each other, and the purines (C and G) hydrogen bond to each other.

As used herein, the terms “ribonucleic acid,” “RNA,” “RNA molecule,” and their equivalents, may refer to a polymer of nucleotides containing ribose. The nucleotides in RNA include cytosine (C), guanine (G), adenine (A), and uracil (U). Each RNA nucleotide includes a ribose and a phosphate group. In an example RNA molecule, the phosphate group of the nth nucleotide is covalently bonded to the ribose of the (n−1)th nucleotide, wherein n is a positive integer greater than 2 and less than or equal to the number of RNA nucleotides in the chain. Messenger RNA (mRNA) is a type of RNA molecule that is synthesized (or “transcribed”) by RNA polymerase (an enzyme) to be complementary to a gene encoded in a DNA sequence, and is also used by a ribosome to synthesize a polypeptide or protein. An mRNA is therefore an example of a “coding RNA.” In various cases, intron sequences are removed from an mRNA via a process known as “RNA splicing.” MicroRNA (“miRNA”) are single-stranded RNA molecules that perform post-transcriptional gene expression regulation. For instance, a miRNA may bind to a complementary mRNA molecule, thereby cleaving, destabilizing, or otherwise preventing the mRNA molecule from being translated into a polypeptide or protein by a ribosome. In various examples, a miRNA has a length in a range of 21 to 23 RNA nucleotides. As used herein, the terms “non-coding RNA” may refer to a type of RNA that is not translated into a protein. Examples of non-coding RNA include miRNA, transfer RNA (tRNA), and ribosomal RNA (rRNA). The term “functional RNA,” and its equivalents, may refer to any RNA molecule that impacts a biological process. For instance, functional RNA may include mRNA, miRNA, tRNA, rRNA, and the like.

As used herein, the terms “nucleotide,” “nucleobase,” “nucleic acid,” “nucleic acid molecule,” and their equivalents, may refer to an organic molecule that includes a nitrogenous base, a sugar, and a phosphate group. In various cases, a nucleotide is a monomer of DNA or RNA. A nucleotide, for instance, is a chemical structure.

As used herein, the term “sequencing,” and its equivalents, may refer to a process of identifying the order and identity of monomers in a polymer chain, such as the order and identity of nucleotides in a DNA or RNA molecule. The terms “whole genome sequencing,” “WGS,” “full genome sequencing” and their equivalents, may refer to the process of sequencing an entire genome of a subject, including the introns and exons of the genes of the subject. The terms “whole exome sequencing,” “WES,” and their equivalents, may refer to the process of sequencing all exomes of a subject. The term “targeted sequencing,” and its equivalents, may refer to the process of sequencing a portion of the genome of a subject, such as sequencing a single gene of the subject. Various techniques can be utilized to sequence a DNA or RNA molecule, such as massively parallel sequencing (MPS), nanopore sequencing, direct sequencing, Sanger sequencing, or next-generation sequencing. In various cases, sequencing is performed on physical molecules (e.g., RNA or DNA) and is used to generate data.

As used herein, the term “amplifying,” and its equivalents, may refer to a process of generating copies of a target molecule, such as a nucleic acid molecule.

As used herein, the term “condition,” and its equivalents, may refer to the state of an individual's health. A condition may refer to a positive state (e.g., a visual acuity that is better than 20/20 vision, nonpathological hypotension, etc.), a normal state (e.g., a normal blood pressure), a negative state (e.g., a pathological condition, such as cancer), or any combination thereof.

As used herein, the term “pathological condition,” “pathology,” “disease,” and their equivalents, may refer to an abnormal anatomical, physiological, or psychological condition that reduces one or more functional abilities below a typical efficiency. As a result of a pathological condition, a subject may have an impaired function, pain, reduced life expectancy, or some other negative health consequence.

As used herein, the term “cancer,” and its equivalents, may refer to a condition of a subject in which particular cells (referred to as “cancer cells”) divide uncontrollably in the subject's body. In some cases, a cancer is characterized by a location or tissue type from which the cancer cells originated. In some examples, a cancer is characterized by a location or tissue type in which the cancer cells are located. Cancer is a type of pathological condition.

As used herein, the terms “tumor,” “neoplasm,” and their equivalents, may refer to a mass of tissue including cancer cells.

As used herein, the terms “tissue of origin,” “tissue origin,” and their equivalents, refers to a differentiated type of tissue from which cancer cells in the body of a subject began dividing uncontrollably in the subject's body.

As used herein, the terms “liquid biopsy,” “fluid biopsy,” and their equivalents, may refer to a process of obtaining a fluid sample from a subject's body. The sample, for instance, can be referred to as a “liquid biopsy sample.” Examples of fluids that are sampled from the body include blood, plasma, cerebrospinal fluid, sputum, stool, urine, lymphatic fluid, and saliva.

As used herein, the term “tissue biopsy,” and its equivalents, may refer to a process of obtaining a sample of cells from a subject's body. A tissue biopsy, in various cases, is performed by cutting a mass of cells from the subject's body. For instance, a tissue biopsy is a procedure performed by a surgeon, interventional radiologist, interventional cardiologist, or other specialized clinician. The term “tissue” or “tissue biopsy sample” can be used to refer to the sample of cells obtained using a tissue biopsy.

As used herein, the term “subject,” and its equivalents, may refer to a human or non-human animal. A subject that is receiving care from at least one care provider may be referred to as a “patient.”

As used herein, the term “clinical trial,” and its equivalents, may refer to a research study used to evaluate a hypothesis based on participation by one or more subjects. In various examples, a clinical trial can be used to assess the efficacy and/or safety of a proposed therapy. A clinical trial may be performed in furtherance of approval of a treatment by a regulatory authority (e.g., the United States Food & Drug Administration (FDA)).

### Description of Example Implementations

Various implementations of the present disclosure will now be described with reference to the accompanying Figures.

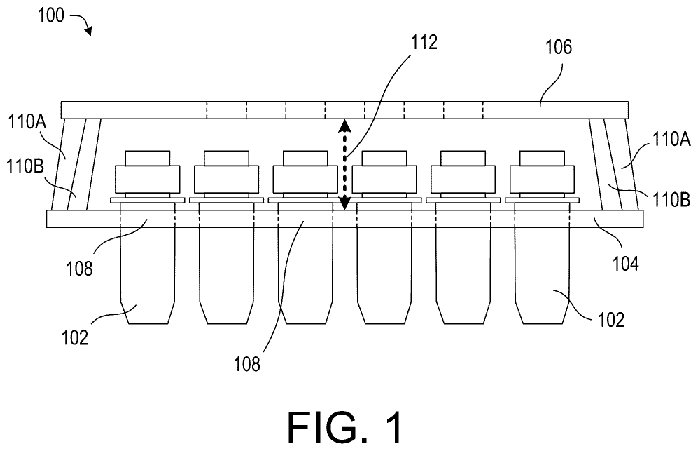

FIG. 1 illustrates an example of a tube rack 100 configured to hold a set of tubes 102. The tube rack 100 may have a base 104 and a lid 106. The base 104 may define a set of base holes 108, into which tubes 102 may be removably inserted. For example, tubes 102 may be inserted into and held within base holes 108 of the tube rack 100, for instance during transport and/or storage of the tubes 102.

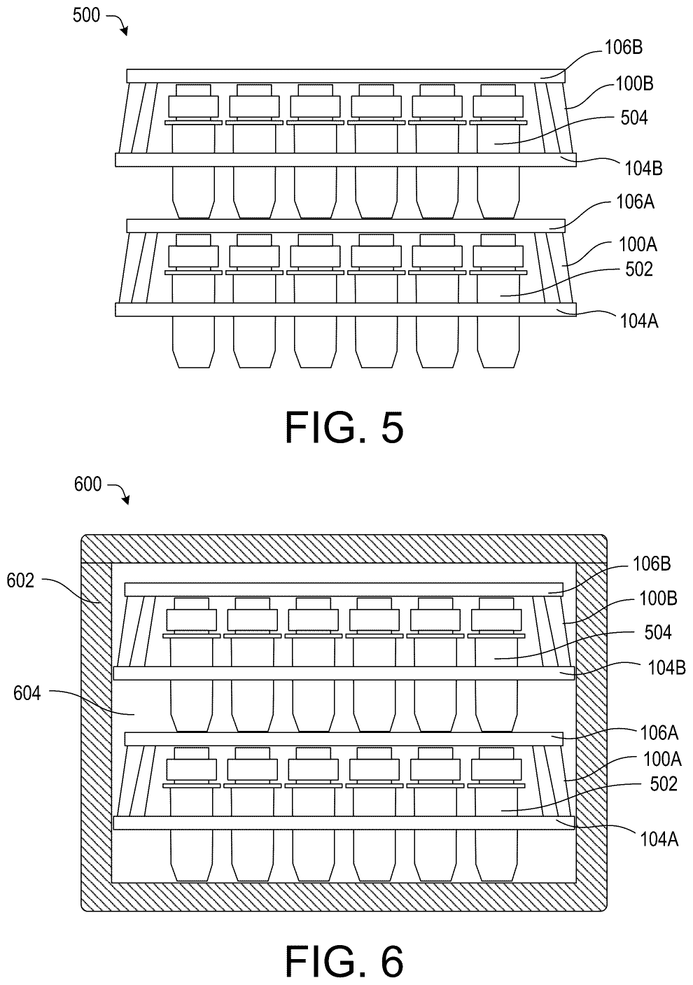

The tube rack 100 may be configured to be stackable, such that an instance of the tube rack 100 may be stacked on another instance of the tube rack 100. As discussed further below with respect to FIG. 5 and FIG. 6, the lid 106 of the tube rack 100 may be configured such that multiple instances of the tube rack 100, respectively holding different sets of tubes 102, may be stacked. As an example, a first tube rack 100 may hold a first set of tubes 102, and a second tube rack 100 may hold a second set of tubes 102. In this example, the second tube rack 100 and/or a set of tubes 102 held by the second tube rack 100 may be placed on, and be supported by, the lid 106 of the first tube rack 100. Such stacked tube racks 100 may in some examples be placed within an outer container, such as an insulated cooler or a shipping box, so that tubes 102 held by the stacked tube racks 100 may be stored and/or transported within the outer container.

The tubes 102 may be lysis tubes, centrifuge tubes, test tubes, and/or other types of tubes that may store liquids and/or other substances or materials. For instance, in some examples the tubes 102 may be filtered or non-filtered lysis tubes, such as Hamilton® AutoLys tubes.

In some examples, the tubes 102 may store biological samples associated with subjects, such as patients, clinical trial participants, and/or other subjects. In some examples, the biological samples stored in the tubes 102 may be liquid biopsy samples obtained via liquid biopsy processes. For instance, the biological samples stored in the tubes 102 may be, or include, blood, plasma, cerebrospinal fluid, sputum, stool, urine, lymphatic fluid, saliva, or other types of biological samples. In other examples, the biological samples stored in the tubes 102 may be tissue biopsy samples obtained via tissue biopsy processes, or other types of biological samples.

Operations may be performed on biological samples stored in tubes 102, such as operations to test the biological samples, purify the biological samples, or extract elements from the biological samples. For instance, DNA in a biological sample may be extracted via lysis processes by disrupting cellular structure of the sample to create lysate, by removing debris from the lysate, and by isolating the DNA from the lysate. The DNA from the biological sample may then be sequenced, amplified, and/or otherwise processed.

As an example, a tube 102 may be a lysis tube that stores a saliva sample collected from a subject. The lysis tube may have an outer tube and an inner tube. The inner tube may at least initially hold the collected saliva sample. Introduction of regents, incubation, centrifugation, and or other operations may be performed on the saliva sample in the tube 102 to create lysate, and to filter the lysate from the inner tube into the outer tube while other elements of the saliva sample remain in the inner tube. The lysate in the outer tube may then be used for DNA extraction, DNA purification, and/or DNA analysis, such as sequencing and/or amplification of DNA.

As discussed above, the base 104 of the tube rack 100 may define a set of base holes 108. Tubes 102 may be inserted into, and be removed from, the base holes 108. As a non-limiting example, the base 104 of the tube rack 100 may define forty-eight base holes 108, such that the tube rack 100 may hold up to forty-eight tubes 102 and thereby be capable of storing a “half plate” of biological samples. In other examples, the base 104 may define any other number of base holes 108, such as fewer than forty-eight base holes 108 or more than forty-eight base holes 108.

The base 104 and the lid 106 of the tube rack 100 may be substantially planar components. For example, the base 104 and the lid 106 may be components, such as substantially square components, substantially rectangular components, or components having any other shape, that extend substantially along corresponding planes. When the base 104 extends along a horizontal plane, surfaces on opposite faces of the base 104 may be referred to herein as a top surface and a bottom surface. Similarly, when the lid 106 extends along a horizontal plane, surfaces on opposite faces of the lid 106 may be referred to herein as a top surface and a bottom surface.

One or more connectors 110 may extend from the base 104 and/or the lid 106. The connectors 110 may selectively couple the base 104 and the lid 106 together. The connectors 110 may be legs or other extensions that protrude from the base 104 and/or the lid 106. The connectors 110 may be shaped and/or oriented to be at least partially angled relative to planes along which the base 104 and the lid 106 extend. The connectors 110 may also be shaped and/or oriented such that a gap 112 separates a top surface of the base 104 and a bottom surface of the lid 106 at times when the base 104 is attached to the lid 106 via the connectors 110. The base 104 and the lid 106 may be substantially parallel to each other at a time when the base 104 and the lid 106 are connected via the connectors 110, as shown in FIG. 1.

As discussed above, the base 104 of the tube rack 100 may define a set of base holes 108 into which tubes 102 may be removably inserted. As shown in FIG. 1, when a tube 102 is inserted into a base hole 108 of the base 104, a top end of the tube 102 may be positioned above a top surface of the base 104, a length of the tube 102 may extend through the base hole 108, and a bottom end of the tube 102 may be positioned below a bottom surface of the base 104.

Also as shown in FIG. 1, if one or more tubes 102 are inserted into the base holes 108 of the base 104, and the lid 106 is connected to the base 104 via one or more connectors 110, the tops of the tubes 102 may be positioned within the gap 112 between the top surface of the base 104 and the bottom surface of the lid 106. For example, if a top end of a tube 102 inserted into a base hole 108 is covered by a cap, the cap at the top end of the tube 102 may be positioned within the gap 112, above the top surface of the base 104 and below the bottom surface of the lid 106.

In some examples, the connectors 110 may include base connectors 110A that extend from the base 104 at positions proximate to edges of the base 104, and lid connectors 110B that extend from the lid 106 at positions proximate to edges of the base 104. For example, a base connector 110A may be a first extension that protrudes from a position proximate to an edge of the base 104, while a lid connector 110B may be a second extension that protrudes from a position proximate to an edge of the lid 106. The base connectors 110A may extend upwards, relative to an upper surface of the base 104, at acute angles such that the base connectors 110A are angled towards a centerline of the base 104. The lid connectors 110B may extend downwards, relative to a bottom surface of the lid 106, at obtuse angles such that the lid connectors 110B are angled away from a centerline of the lid 106.

The base connectors 110A and the lid connectors 110B may be oriented at angles such that the base connectors 110A and the lid connectors 110B may be directly adjacent to one another and may interact to at least partially couple the lid 106 to the base 104. For example, lid connectors 110B on opposing sides of the lid 106 may be spaced closer together than corresponding base connectors 110A on opposing sides of the base 104, as shown in FIG. 1.

The lid 106 may be slidable relative to the base 104. When a user slides the lid 106 into position above the base 104 to place the lid 106 and the base 104 into a connected configuration, lid connectors 110B extending below the lid 106 may slide between, and at least partially under, corresponding base connectors 110A extending above the base 104. When the base and the lid 106 are in such a connected configuration, an inner side of a base connector 110A may be adjacent to, and/or may contact, an outer side of a corresponding lid connector 110B. If and when the lid 106 is lifted vertically, the lid connectors 110B between and at least partially under the base connectors 110A may pull up on the base connectors 110A, such that pulling up the base connectors 110A also causes the base 104 and any tubes 102 held by the base 104 to be lifted.

In some examples, the base connectors 110A the lid connectors 110B, and/or other elements of the tube rack 100 may have protrusions, groves, stoppers, and/or other components that may limit sliding of the lid 106 relative to the base 104. For example, protrusions on one or more base connectors 110A may be lip protrusions that prevent corresponding lid connectors 110B from sliding beyond a predefined location on the base connectors 110A, and thereby prevent sliding of the lid 106 beyond a predefined point relative to the base 104.

As discussed above, in some examples the connectors 110 may allow the lid 106 to be at least temporarily coupled to the base 104 by sliding the lid 106 relative to the base 104, such that lid connectors 110B interface with, and are positioned at least partially below, corresponding base connectors 110A. However, in other examples the connectors 110 may include snap-fit connectors, interlocking components, latches, locks, hinges, and/or other components that may selectively couple the lid 106 to the base 104 and/or lock the lid 106 into place above the base 104.

As a non-limiting example, one side of the tube rack 100 may have a hinged joint that connects the lid 106 to the base 104, and that allows the lid 106 to be moved relative to the base 104. An opposing side of the tube rack 100 may have one or more locks, latches, or other mechanisms that may be used to lock the lid 106 in position to be parallel to the base 104 with the gap 112 between the base 104 and the lid 106, and that may be used to unlock the lid 106 and allow the lid 106 to move relative to the base 104 via the opposing hinged joint.

As discussed above, the base 104 may be a substantially planar component that defines a set of base holes 108. The base 104 may have any number of base holes 108. The base holes 108 may be arranged in one or more grids having rows and columns of base holes 108, staggered configurations base holes 108, and/or other arrangements. The base holes 108 may be sized to fit corresponding portions of tubes 102, and adjacent base holes 108 may be separated by at least a portion of the base 104. In some examples, the lid 106 may be a substantially planar component that has similar or smaller dimensions than the base 104. For instance, in some examples the lid 106 may have substantially the same length as the base 104, but have a smaller width than the base 104. In these examples, the smaller width of the lid 106 may allow lid connectors 110B, extending from positions proximate to edges of the lid 106, to extend at an outward angle below a bottom surface of the lid 106 in order to slide between and/or under corresponding base connectors 110A that extend upward and inward from positions proximate to edges of the wider base 104.

As a non-limiting example, the base 104 may have a width of 146 millimeters (mm), a length of 196 mm, and a depth of 4 mm, and the lid 106 may have a width of 134 mm, a length of 196 mm, and a depth of 4 mm. In this example, the connectors 110 may have dimensions such that there is a gap 112 of around 20 mm between the top surface of the base 104 and the bottom surface of the lid 106 when the base 104 and the lid 106 are coupled together via the connectors 110. In this example, the base 104 may define forty-eight base holes 108 arranged in one or more grids, the base holes 108 may each have a diameter of 16.5 mm, and the base holes 108 may be extruded through the entire 4 mm depth of the base 104. Edges of the base holes 108 may be spaced apart within the base 104 by at least 3.5 mm in this example.

Although particular dimensions are provided in the example discussed above, in other examples elements of the tube rack 100 may have other dimensions. For example, the width of the base 104 may be larger or smaller than 146 mm, the width of the lid 106 may be larger or smaller than 134 mm, the lengths of the base 104 and/or the lid 106 may be larger or smaller than 196 mm, the depths of the base 104 and/or the lid 106 may be larger or smaller than 4 mm, the connectors 110 may be sized and/or shaped such that the gap 112 is larger or smaller than 20 mm, the diameters of the base holes 108 may be larger or smaller than 16.5 mm, and/or spaces between adjacent base holes 108 may be larger or smaller than 3.5 mm.

In some examples, the tops of the base holes 108 may be shaped with chamfers that are angled relative to the upper surface of the base 104 and lower portions of the base holes 108, and/or are wider than the lower portions of the base holes 108. Such chamfers may assist users with inserting tubes 102 into the base holes 108, and/or removing tubes 102 from the base holes 108, for instance by providing tolerance for the user to at least slightly angle the tubes 102 relative to center axes of the base holes 108. The chamfers may in some examples also be sized, shaped, or angled based on shapes of corresponding outer portions of the tubes 102, for instance to allow the tubes 102 to fit more securely in the base holes 108.

In some examples, the lid 106 may define lid holes 114 similar to the base holes 108. The lid holes 114 may be sized with smaller diameters than the base holes 108. As a non-limiting example, if the base holes 108 have diameters of 16.5 mm, the lid holes 114 may have diameters of 15 mm. In other examples, the base holes 108 and/or the lid holes 114 may have larger or smaller diameters.

Accordingly, while tubes 102 may extend through the base holes 108, the lid holes 114 may be sized such that tubes 102 do not extend fully through the lid holes 114. As a non-limiting example, if lower portions of tubes 102 that extend below caps and/or top ends of the tubes 102 have diameters of 16 mm, the tubes 102 may fit into and through the 16.5 mm diameters of the base holes 108, but not fit through the 15 mm diameters of the lid holes 114. In some examples, the lid holes 114 may be sized such that bottom ends of tubes 102 do not fit into the lid holes 114, or may partially extend into the lid holes 114 without allowing the tubes 102 to extend fully through the lid holes 114.

Accordingly, when a tube rack 100 holding a set of tubes 102 is stacked above a lower tube rack 100, the tubes 102 held by the upper tube rack 100 may rest on the lid 106 of the lower tube rack 100 without those tubes falling through the lid holes 114 of the lid 106 of the lower tube rack 100. In some examples, bottoms of some of the tubes 102 held by the upper tube rack 100 may partially fit into lid holes 114 of the lid 106 of the lower tube rack 100, which may assist with stabilizing or retaining the placement of the upper tube rack 100, and/or the tubes 102 held by the upper tube rack 100, relative to the lower tube rack 100.

The lid holes 114 may in some situations be used as finger holes that a user may grab to raise the tube rack 100. For example, a user may insert one or more of the user's fingers through respective lid holes 114 in order to grasp the lid 106, and may then pull up on the lid 106 to lift the entire tube rack 100. A user may accordingly grab the lid 106, via fingers inserted into lid holes 114, when placing the tube rack 100 into an outer container, when removing the tube rack 100 from an outer container, and/or when otherwise moving the tube rack 100 or the lid 106. As discussed further below, the base 104 and/or the lid 106 may also, or alternately, be shaped with other finger hold indentations that may allow a user to position a finger between the base 104 and/or the lid 106 and walls of an outer container, and/or below the base 104 and/or the lid 106. Such finger hold indentations may also, or alternately, be used by a user when the user is placing the tube rack 100 into an outer container, when removing the tube rack 100 from an outer container, and/or when otherwise moving the tube rack 100.

In some examples, centers of a least a subset of the lid holes 114 may be vertically aligned with centers of corresponding base holes 108 when the lid 106 is in position above the base 104. Accordingly, the lid holes 114 may allow a user to see through the lid holes 114 from above, for instance to see whether tubes 102 are inserted into base holes 108 below the lid 106.

In some examples, the tube rack 100 may have fewer lid holes 114 than base holes 108. As a non-limiting example, if the tube rack 100 has forty-eight base holes 108 but the lid 106 has a smaller width than the base 104, the lid 106 may define thirty-six lid holes 114 due to the smaller width of the lid 106. However, in other examples, the tube rack 100 may have equal numbers of lid holes 114 and base holes 108, or have more lid holes 114 than base holes 108.

The components of the tube rack 100 may be formed from plastic, metal (e.g., stainless steel), wood, glass, acrylic, and/or any other materials. For instance, in some examples, the base 104 and its base connectors 110A, and the lid 106 and its lid connectors 110B, may be 3D printed components formed of ABS (Acrylonitrile Butadiene Styrene), Acrylic Styrene Acrylonitrile (ASA), Polylactic Acid (PLA), Polyethylene Terephthalate (PET), and/or other materials. In other examples, components of the tube rack 100 may be manufactured via injection molding, machine tooling, and/or other manufacturing techniques. In some examples, the components of the tube rack 100 may include one or more autoclavable materials.

In some examples in which the tube rack 100 is configured to hold tubes 102 that may contain temperature-sensitive biological samples, and may be placed into an insulated container or other temperature-controlled environment, the tube rack 100 may be formed from a cold-resistant plastic or other cold-resistant material. For instance, the components of the tube rack 100 may be 3D printed components formed of ABS, because ABS may be likely to maintain structural integrity, strength, and impact resistance qualities in freezing temperatures.

In some examples, the tube rack 100 may be reusable, such that the same tube rack 100 may be used to hold different sets of tubes 102 at different times. For example, the tube rack 100 may be used to hold a first shipment of tubes 102 being transported to a destination, and then later be re-used to hold a second shipment of tubes 102 being transported to the same destination or a different destination. The tube rack 100 may accordingly be made of one or more materials that may be cleaned and/or sterilized between uses, for instance via water, soap, cleaning solutions, autoclaves, or other cleaning techniques.

Overall, a set of tubes 102 may be inserted into the base holes 108 defined by the base 104 of the tube rack 100. The lid 106 of the tube rack 100 may be coupled to the base 104, for instance by sliding the lid 106 relative to the base 104 such that connectors 110 hold the lid 106 in place above the base 104 and above the set of tubes 102 held by the base 104. In some situations, another set of tubes 102 may be similarly inserted into another tube rack 100, and the tube racks 100 may be stacked. For instance, another tube rack 100 holding another set of tubes 102 may be stacked above, and be supported by, the lid 106 of the tube rack 100. The stacked tube racks 100 may fit within the inner dimensions of an outer container, such that the stacked tube racks 100 may be stored and/or transported together within the outer container, as discussed further below.

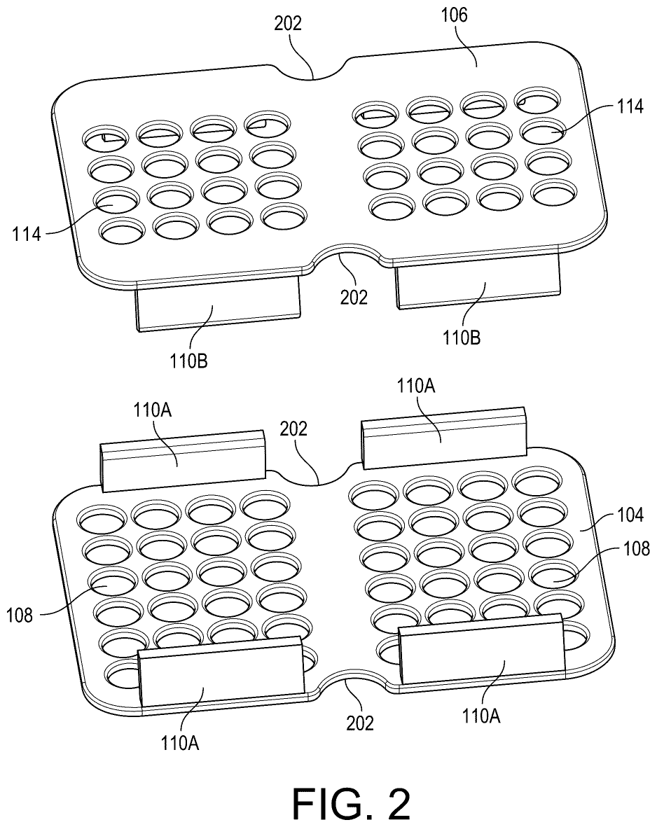

FIG. 2 shows an angled top view of the tube rack 100 in a disconnected configuration in which the lid 106 is disconnected from the base 104. As shown in FIG. 2, the base 104 and the lid 106 may be substantially rectangular components. The base 104 may define a set of base holes 108, and in some examples the lid 106 may define a set of lid holes 114.

In some examples, corners of the base 104 and/or the lid 106 may be rounded or smooth. For instance, corners of the base 104 and/or the lid 106 may be shaped to have 20 mm fillets, fillets of any other larger or smaller size, or other rounded or smooth shape.

One or more side edges of the base 104 and/or the lid 106 may be shaped to define one or more finger holds 202. The finger holds 202 may be indentations formed into corresponding sides of the base 104 and/or the lid 106. The finger holds 202 may allow a user to reach a finger under the base 104 and/or the lid 106 even if another object, such as a wall of an outer container, is adjacent to the sides of the base 104 and/or the lid 106. Accordingly, the user may grab and/or pull up on the base 104 and/or the lid 106 by using the finger holds 202. The user may also, or alternately, insert fingers into one or more of the lid holes 114 defined in the lid 106, and thereby grasp the lid 106 via the lid holes 114 when holding or moving the lid 106 and/or the entire tube rack 100.

In some examples, the base 104 may have multiple base connectors 110A along a shared edge of the base 104, extending from positions that are separated by a corresponding finger hold 202 on that edge. As a non-limiting example, and as shown in FIG. 2, the base 104 may have four base connectors 110A that extend from positions on two opposing edges of the base 104. Each of the opposing edges of the base 104 may define a finger hold 202. Each of the opposing edges of the base 104 may also have two base connectors 110A that extend from positions on opposite sides of the finger hold 202 on that edge.

Similarly, the lid 106 may have multiple lid connectors 110B along a shared edge of the lid 106, extending from positions that are separated by a corresponding finger hold 202 on that edge. As a non-limiting example, and as shown in FIG. 2, the lid 106 may have four lid connectors 110B that extend from positions on two opposing edges of the lid 106. The four lid connectors 110B may be configured to slide between, and thereby interface with, the four corresponding base connectors 110A extending from the base 104. Each of the opposing edges of the lid 106 may define a finger hold 202. Each of the opposing edges of the lid 106 may also have two lid connectors 110B that extend from positions on opposite sides of the finger hold 202 on that edge.

Tubes 102 may be removably inserted into the base holes 108 of the base 104. The base 104 may have any number and/or arrangement of base holes 108. However, as a non-limiting example, and as shown in FIG. 2, the base 104 may define forty-eight base holes 108 that are arranged into two grids of twenty-four base holes 108 each. The two grids of base holes 108 may be on opposing sides of the base 104, for example on opposite sides of a line extending between the finger holds 202 on opposing edges of the base 104.

The lid 106 may have similar arrangements of lid holes 114. As a non-limiting example, and as shown in FIG. 2, the lid 106 may define thirty-six lid holes 14 that are arranged into two grids of sixteen lid holes 114 each. The two grids of lid holes 114 may be on opposing sides of the lid 106, for example on opposite sides of a line extending between the finger holds 202 on opposing edges of the lid 106.

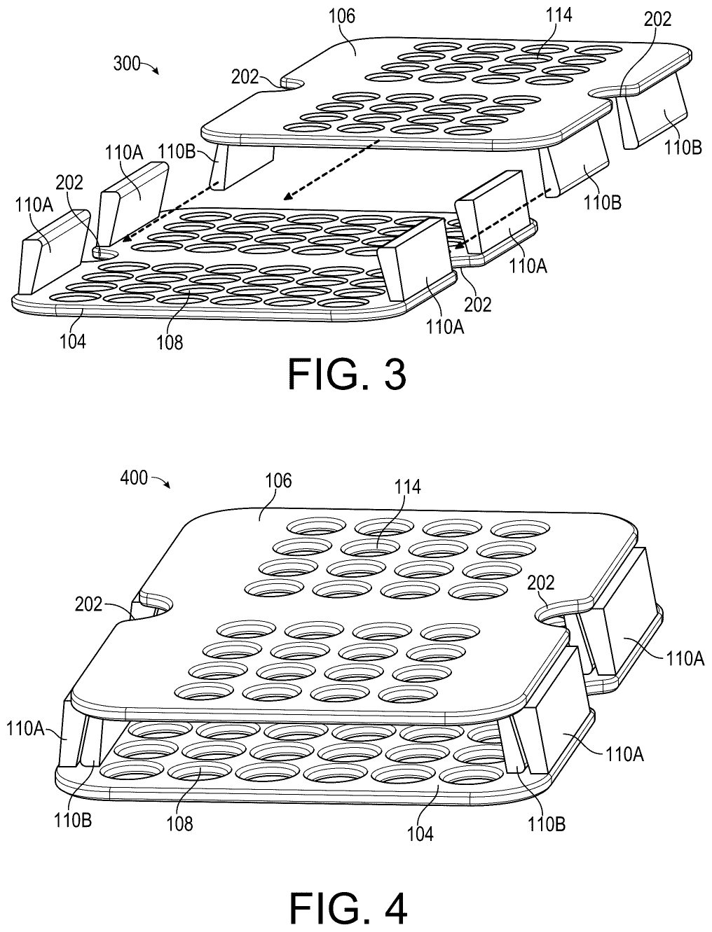

In some examples, tubes 102 may be inserted into base holes 108 of the base 104 while the tube rack 100 is in the disconnected configuration shown in FIG. 2. For example, tubes 102 may be lowered into, or otherwise inserted into, base holes 108 defined in the base 104. The lid 106 may then be coupled to the base 104 in a connected configuration, such that the lid 106 extends over the tops of the tubes 102 inserted into the base holes 108 of the base 104. Examples of the lid 106 being coupled with the base 104, for instance to move the tube rack 100 from the disconnected configuration shown in FIG. 2 into a connected configuration, are shown in FIG. 3 and FIG. 4, and are discussed further below with respect to those figures.

FIG. 3 shows an example 300 in which the lid 106 may slide into place above the base 104, to place the tube rack 100 in a connected configuration. As discussed above, the connectors 110 of the tube rack 100 may include base connectors 110A that extend upward and inward from a top surface of the base 104, and lid connectors 110B that extend downwards and outward from a bottom surface of the lid 106. The connectors 110 may be shaped such that the lid connectors 110B fit between, and at least partially under, the base connectors 110A. Accordingly, as shown in FIG. 3, the lid 106 may be slid over and across the base 104 such that the lid connectors 110B slide between the base connectors 110A.

In some examples, one or more of the connectors 110 may have lip protrusions or other elements that may prevent the lid 106 from sliding beyond a predefined point relative to the base 104. As an example, a lip protrusion may extend inward from an edge of a base connector 110A, to serve as a stopper that prevents a corresponding lid connector 110B from passing beyond the lip protrusion. In these examples, such lip protrusions or other elements may allow the lid 106 to slide in and out of the base 104 from one side of the base 104, but prevent the lid 106 from sliding in or out of the base 104 from an opposing side of the base 104.

When the lid 106 is separated from the base 104, or is slid relative to the base 104 such that the base holes 108 are not covered by the lid 106, a user may insert tubes 102 into the base holes 108 of the base 104. The user may then slide the lid 106 into place above the base 104 as shown in FIG. 3. Accordingly, the lid 106 may be positioned above, and may cover, the tops of the tubes 102 inserted into the base holes 108. Similarly, a user may slide the lid 106 out of, and/or away from, the base 104 such that the lid 106 does not cover the base holes 108 and any inserted tubes 102 may be removed from the base holes 108.

FIG. 4 shows an example 400 in which the tube rack 100 is a connected configuration. As discussed above, the lid 106 may be coupled with the base 104 via sliding motions or other movements to place the tube rack 100 into a connected configuration. In the connected configuration, the lid 106 may be positioned substantially parallel to the base 104, and the lid 106 may be spaced apart from the base 104 by a gap 112.

If any tubes 102 are inserted into the base holes 108 of the base 104, the tubes 102 may extend through the base holes 108 such that bottom ends or bottom surfaces of the tubes 102 are positioned below a bottom surface of the base 104. However, the tops of the tubes 102 may be positioned within the gap 112 above a top surface of the base 104 and a below a bottom surface of the lid 106, such that the tops of the tubes 102 are covered by the lid 106. Accordingly, because tops of tubes 102 inserted into the tube rack 100 may be covered by the lid 106 of the tube rack 100, a second tube rack 100 may be stacked above the tube rack 100 without contacting or disturbing the tubes 102 inserted into the tube rack 100, as discussed further below with respect to FIG. 5.

FIG. 5 shows an example 500 of stacked tubes racks 100 that hold respective sets of tubes 102. For example, a first tube rack 100A may hold a first set 502 of tubes 102, and a second tube rack 100B may hold a second set 504 of tubes 102.

Tubes 102 in the first set 502 may be inserted into base holes 108 of a base 104A of the first tube rack 100A, and a lid 106A of the first tube rack 100A may be coupled to the base 104A in order to place the first tube rack 100A into a connected configuration. As shown in FIG. 5, the tops of the tubes 102 in the first set 502 may be within a gap 112 between the base 104A and the lid 106A of the first tube rack 100A, and may be covered by the lid 106A of the first tube rack 100A. Bottoms of the tubes 102 in the first set 502 may extend below the base 104A of the first tube rack 100A.

Similarly, tubes 102 in the second set 504 may be inserted into base holes 108 of a base 104B of the second tube rack 100B, and a lid 106B of the second tube rack 100B may be coupled to the base 104B in order to place the second tube rack 100B into a connected configuration. As shown in FIG. 5, the tops of the tubes 102 in the second set 504 may be within a gap 112 between the base 104B and the lid 106B of the second tube rack 100B, and may be covered by the lid 106B of the second tube rack 100B. Bottoms of the tubes 102 in the second set 504 may extend below the base 104B of the second tube rack 100B.

The first tube rack 100A and the second tube rack 100B may be stacked by placing the second tube rack 100B above the lid 106A of the first tube rack 100A. The bottoms of the tubes 102 in the second set 504, inserted into the second tube rack 100B, may rest on the lid 106A of the first tube rack 100A. In some examples, bottoms of some or all tubes 102 in the second set 504 may fit partially into lid holes 114 in the lid 106A of the first tube rack 100A. However, the lid 106A of the first tube rack 100A may prevent bottoms of the tubes 102 in the second set 504 from passing though the lid 106A of the first tube rack 100A, thereby allowing the first tube rack 100A and the second tube rack 100B to respectively hold the first set 502 of tubes 102 and the second set 504 of tubes 102 without contact between tubes 102 in the first set 502 and the second set 504.

In some examples, when tubes 102 held in a tube rack 100 are placed on a surface, such as a table, a base of an outer container, or a lid 106 of another tube rack 100, the tubes 102 may shift upwards relative to the base 104 of the tube rack 100. However, the tops of the tubes 102 may press against the lid 106 of the tube rack 100 and/or fit partially into the lid holes 114 of the lid 106 without fully passing through the lid 106. Accordingly, even if the tubes 102 in the first set 502 shift upward such that the tops of the tubes 102 become closer to, or are pressed against, the bottom surface of the lid 106A, the lid 106A may prevent the bottoms of the tubes 102 in the second set 504 that rest on the top surface of the lid 106A from coming into contact with the tops of the tubes in the first set 502.

In other examples, one or more legs or other elements may extend below the bases 104 of the first tube rack 100A and/or the second tube rack 100B, below the bottoms of the tubes 102 inserted into the bases 104. Accordingly, in these examples, one or more legs of the base 104A of the first tube rack 100A may contact and rest on a surface below the first tube rack 100A, and thereby prevent the bottoms of the first set 502 of tubes 102 from contacting the surface below the first tube rack 100A. Similarly, one or more legs of the base 104B of the second tube rack 100B may contact and rest on the top surface of the lid 106A of the first tube rack 100A, and thereby prevent the bottoms of the second set 504 of tubes 102 from contacting the lid 106A of the first tube rack 100A.

Overall, the first tube rack 100A and the second tube rack 100B may be stacked, such that the first set 502 and the second set 504 of tubes 102 respectively held by the first tube rack 100A and the second tube rack 100B may also be stacked. In some situations, stacked tube racks 100 may be stored and/or transported within an outer container, as discussed further below with respect to FIG. 6.

FIG. 6 shows an example 600 in which stacked tube racks 100 are within an outer container 602. The outer container 602 may be a box, cooler, or other type of container. The outer container 602 may have walls, a floor, a lid, and/or other elements that surround and/or define an interior space 604 of the outer container 602. The tube racks 100 may be stacked within the interior space 604 of the outer container 602, or may be placed within the interior space 604 of the outer container 602 after being stacked.

For example, the first tube rack 100A holding the first set 502 of tubes 102 may be placed into the outer container 602 first, such that bottoms of the first set 502 of tubes 102 rest on the floor of the outer container 602. The second tube rack 100B holding the second set 504 of tubes 102 may then be placed on top of the lid 106A of the first tube rack 100A, within the outer container 602. Bottoms of the second set 504 of tubes 102 may rest on the lid 106A of the first tube rack 100A. The outer container 602 may then be closed and/or sealed for storage and/or transport, for instance by closing a lid of the outer container 602.

Similarly, the outer container 602 may be opened such that the first tube rack 100A and the second tube rack 100B may be removed from the outer container 602. For example, the second tube rack 100B, holding the second set 504 of tubes 102, may be lifted vertically out of the interior space 604 of the outer container 602. The first tube rack 100A, holding the first set 502 of tubes 102, may also then be lifted vertically out of the interior space 604 of the outer container 602.

In some examples, the outer container 602 may be an insulated cooler or an insulated shipping container made of polystyrene and/or other materials, such as a U-Line® insulated foam container. Such an insulated outer container 602 may be used to store and/or transport biological samples contained within tubes 102. For example, an insulated outer container 602 that holds a set of tubes 102 containing biological samples may be shipped or otherwise transported to a laboratory or other environment where the biological samples are to be tested or otherwise processed. In some cases, an insulated outer container 602 may additionally hold ice, cold packs, or other elements that may help cool or regulate an internal temperature of the interior space 604, in order to cool and/or preserve biological samples within the insulated cooler. Such an insulated outer container 602 may hold stacked tube racks 100 as shown in FIG. 6, such that the stacked tube racks 100 may be stored and/or transported within the insulated outer container 602.

The dimensions of the tube racks 100 may be configured to fit within the dimensions of the interior space 604 of the outer container 602. For example, widths of the bases 104 of the tube racks 100 may be equal to or less than a width of the interior space 604 of the outer container 602, and lengths of the bases 104 of the tube racks 100 may be equal to or less than a length of the interior space 604 of the outer container 602. The widths and lengths of the bases 104 of the tube racks 100 may be configured to be substantially equal to the widths and lengths of the interior space 604 of the outer container 602 in order to minimize space between side edges of the base 104 and inner surfaces of walls of the outer container 602, and to thereby minimize the potential for side-to-side movement of the bases 104 and the overall tube racks 100 within the outer container 602.

Although the widths and lengths of components of the tube racks 100 may be configured such that side edges of the tube rack 100 fit against, or relatively close to, the inner surfaces of walls of the outer container 602, the bases 104 and/or the lids 106 of the tube racks 100 may have indentations that form finger holds 202. Such finger hold 202 indentations may allow a user to fit a finger between inner surfaces of walls of the outer container 602 and portions of the bases 104 and/or the lids 106, and in order to reach below the bases 104 and/or the lids 106 and to grab the tube racks 100 within the outer container 602. In some examples, a user may also grab the lids 106 via lid holes 114, for instance when placing the tube racks 100 into the outer container 602 and/or removing the tube racks 100 from the outer container 602.

The stackable nature of the tube rack 100 described herein may, relative to other types of non-stackable tube racks, allow more tubes 102 to be stored and/or transported in the outer container 602. For example, some non-stackable tube racks may hold up to twenty-four tubes 102, such that one outer container 602 may only hold one non-stackable tube rack with up to twenty-four tubes 102. However, if the base 104 of the tube rack 100 described herein has forty-eight base holes 108, up to ninety-six tubes 102 may be held collectively by two tube racks 100 stacked within the same outer container 602. Accordingly, the stacked tube racks 100 may hold a full plate of ninety-six biological samples, and thus allow the full plate of ninety-six biological samples to be stored and/or transported within one outer container 602. The tube rack 100 described herein may, relative to other types of non-stackable tube racks, increase the number of tubes 102 that may be stored and/or transported within the outer container 602, and thereby reduce storage and/or shipping costs, improve efficiency by reducing wasted space within the outer container 602, and/or have other benefits.

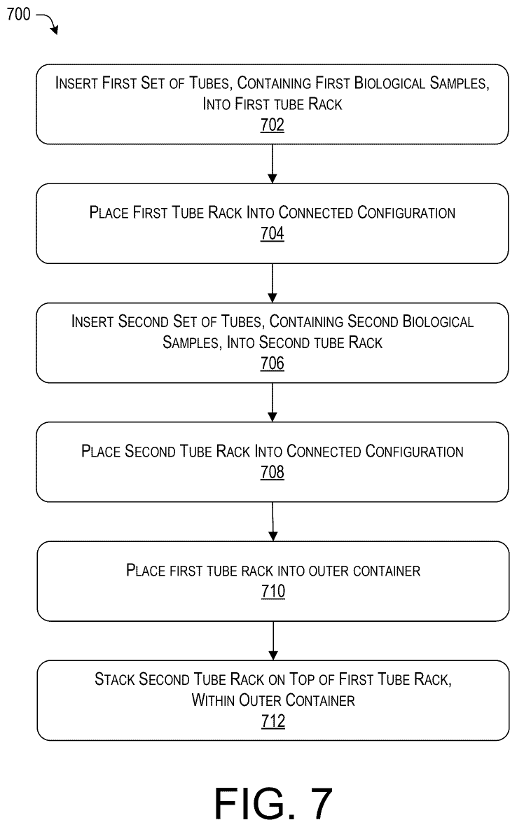

FIG. 7 shows an example of a process 700 for stacking tube racks 100 during storage and/or transport of biological samples. The biological samples may be samples that have been collected from subjects, such as samples of blood, plasma, cerebrospinal fluid, sputum, stool, urine, lymphatic fluid, saliva, or other types of biological samples. The collected biological samples may be stored in tubes 102, such as lysis tubes, centrifuge tubes, test tubes, and/or other types of tubes. For example, when a saliva sample is collected from a subject, the saliva sample may be stored in a lysis tube or other type of tube.

At block 702, a first set of tubes 102, containing a first set of biological samples, may be inserted into first base holes 108 of a first base 104 of a first tube rack 100. Tops of the first set of tubes 102 may be positioned above a top surface of the first base 104, while lengths of the first set of tubes 102 extend through the first base holes 108 such that the bottoms of the first set of tubes 102 are positioned below a bottom surface of the first base 104. Accordingly, the first base holes 108 may receive the first set of tubes 102 at block 702.

At block 704, the first tube rack 100 may be placed into a connected configuration in which the first lid 106 is coupled with the first base 104. In the connected configuration, the first lid 106 may extend over, and cover, the tops of the first set of tubes 102. The tops of the first set of tubes 102 may, when the first tube rack 100 is in the connected configuration, be positioned within a first gap 112 between a top surface of the first base 104 and a bottom surface of the first lid 106. As an example, a user may slide the first lid 106 over the first base 104, such that base connectors 110A interact with lid connectors 110B to couple the first lid 106 with the first base 104.

At block 706, a second set of tubes 102, containing a second set of biological samples, may be inserted into second base holes 108 of a second base 104 of a second tube rack 100. Tops of the second set of tubes 102 may be positioned above a top surface of the second base 104, while lengths of the second set of tubes 102 extend through the second base holes 108 such that the bottoms of the second set of tubes 102 are positioned below a bottom surface of the second base 104. Accordingly, the second base holes 108 may receive the second set of tubes 102 at block 706.

At block 708, the second tube rack 100 into a connected configuration in which the second lid 106 is coupled with the second base 104. In the connected configuration, the second lid 106 may extend over, and cover, the tops of the second set of tubes 102. The tops of the second set of tubes 102 may, when the second tube rack 100 is in the connected configuration, be positioned within a second gap 112 between a top surface of the second base 104 and a bottom surface of the second lid 106. As an example, a user may slide the second lid 106 over the second base 104, such that base connectors 110A interact with lid connectors 110B to couple the second lid 106 with the second base 104.

At block 710, the first tube rack 100 may be placed into an outer container 602, such as a box, insulated cooler, insulated shipping container, or other type of outer container 602. For example, a user may lower the first tube rack 100, holding the first set of tubes 102 inserted at block 702, into the interior space 604 of the outer container 602 such that bottoms of the first set of tubes 102 rest on a floor of the outer container 602.

At block 712, the second tube rack 100 may be stacked on top of the first tube rack 100 within the outer container 602. For example, a user may lower the second tube rack 100, holding the second set of tubes 102 inserted at block 706, into the interior space 604 of the outer container 602 such that bottoms of the second set of tubes 102 rest on the first lid 106 of the first tube rack 100 previously placed into the outer container 602 at block 710.

In some examples, if there is additional space above the first tube rack 100 and the second tube rack 100 within the interior space 604 of the outer container 602, one or more additional tube racks 100, respectively holding additional sets of tube 102 containing additional biological samples, may be stacked within the outer container 602 above the first tube rack 100 and the second tube rack 100. As an example, although FIG. 6 shows an example 600 in which a height of the interior space 604 of an outer container 602 allows two tube racks 100 to be stacked within the outer container 602, other outer containers 602 that have greater heights may permit three tube racks 100, four tube racks 100, or other numbers of tube racks 100 to be stacked within the outer containers 602.

When the tube racks 100 are stacked within the outer container 602, the outer container 602 may be closed and/or sealed, in some cases after ice, cold packs, or other cooling or temperature-regulating elements have also been placed into the interior space 604 of the outer container 602. The outer container 602 may then be stored and/or shipped or otherwise transported, to store and/or transport the biological samples contained within the tubes 102 held by the stacked tube racks 100 within the outer container 602.

### Example Clauses

1. A tube rack, comprising: a substantially planar base having a top surface and a bottom surface opposite the top surface, and defining a plurality of base holes extending from the top surface to the bottom surface, the plurality of holes being configured to removably hold lysis tubes configured to store biological samples of one or more subjects, wherein at a time at which a lysis tube is inserted into a first hole of the plurality of base holes: a cap at a top of the lysis tube is positioned above the top surface of the base, a length of the lysis tube extends through the first hole, and a bottom of the lysis tube is positioned below the bottom surface of the base; a substantially planar lid having a top surface, and a bottom surface opposite the top surface of the lid; and a connector coupled to at least one of the base or the lid, wherein the connector selectively couples the lid to the base in a connected configuration in which: the base extends substantially parallel to the lid, the top surface of the base faces the bottom surface of the lid, the top surface of the base is separated from the bottom surface of the lid by a gap, and at the time at which the lysis tube is inserted into the first hole, the cap of the lysis tube is positioned within the gap between the top surface of the base and the bottom surface of the lid.

2. The tube rack of clause 1, wherein: the tube rack is a first tube rack, and a second tube rack, having a second substantially planar base defining a second plurality of base holes configured to hold second lysis tubes, is stackable on the lid of the first tube rack.

3. The tube rack of clause 2, wherein bottoms of the second lysis tubes, inserted into the second plurality of base holes of the second tube rack, rest on the lid of the first tube rack.

4. The tube rack of clause 2, wherein lengths and widths of the first tube rack and the second tube rack correspond to lengths and widths of an interior space of an insulated shipping container, and are configured to permit the second tube rack to be stacked on the top of the lid of the first tube rack within the insulated shipping container.

5. A tube rack comprising: a substantially planar base defining a plurality of base holes that extend through the base and are configured to hold removable tubes, wherein at a time at which a removable tube is inserted into first hole of the plurality of base holes: a top of the removable tube is positioned above a top surface of the base, a length of the removable tube extends through the first hole, and a bottom of the removable tube is positioned below a bottom surface of the base; a substantially planar lid; and a connector coupled to at least one of the base or the lid, wherein the connector selectively couples the lid to the base in a connected configuration in which: the base extends substantially parallel to the lid, the top surface of the base faces a bottom surface of the lid, the top surface of the base is separated from the bottom surface of the lid by a gap, and at the time at which the removable tube is inserted into the first hole, the top of the removable tube is positioned within the gap between the top surface of the base and the bottom surface of the lid.

6. The tube rack of clause 5, wherein: the tube rack is a first tube rack, and a second tube rack, having a second substantially planar base defining a second plurality of base holes that extend through the second base and are configured to hold second removable tubes, is stackable on the lid of the first tube rack.

7. The tube rack of clause 6, wherein a bottom surface of each of the second removable tubes, inserted into the second plurality of base holes of the second tube rack, rest on the lid of the first tube rack.

8. The tube rack of clause 6, wherein lengths and widths of the first tube rack and the second tube rack correspond to lengths and widths of an interior space of an outer container, and are configured to permit the second tube rack to be stacked on the top of the lid of the first tube rack within the outer container.

9. The tube rack of clause 8, wherein the outer container is a shipping box.

10. The tube rack of clause 8, wherein the outer container is an insulated cooler.

11. The tube rack of any of clauses 5 to 10, wherein at least one edge of the lid has a finger hold indentation.

12. The tube rack of any of clauses 5 to 11, wherein the lid defines a plurality of lid holes.

13. The tube rack of clause 12, wherein in the connected configuration at least a subset of the plurality of lid holes vertically align, along center points, with corresponding base holes of the base.

14. The tube rack of clause 12, wherein a first diameter of an individual lid hole, of the plurality of lid holes, is less than a second diameter of an individual base hole, of the plurality of base holes.

15. The tube rack of any of clauses 5 to 14, wherein the connector comprises: a first extension protruding, from a first position proximate to a first edge of the base, above the top surface of the base; and a second extension protruding, from a second position proximate to a second edge of the lid, below the bottom surface of the lid.

16. The tube rack of clause 15, wherein the first extension and the second extension are oriented at an acute angle relative to an orientation of the base.

17. The tube rack of clause 15, wherein in the connected configuration, an inner side of the first extension contacts an outer side of the second extension.

18. The tube rack of clause 15, wherein the first extension and the second extension are configured to slidably interact to selectively couple the lid to the base in the connected configuration.

19. The tube rack of clause 18, wherein at least one of the first extension or the second extension comprises a lip protrusion configured to prevent the lid from sliding, relative to the base, beyond a predefined location.

20. The tube rack of any of clauses 5 to 19, wherein the plurality of base holes comprises forty-eight base holes.

21. The tube rack of any of clauses 5 to 20, wherein a length and a width of the base corresponds to a length and a width of an interior space of an outer container configured to removably hold the tube rack.

22. The tube rack of clause 21, wherein the outer container is a shipping box.

23. The tube rack of clause 21, wherein the outer container is an insulated cooler.

24. The tube rack of any of clauses 5 to 23, wherein the removable tubes are configured to store biological samples of one or more subjects.

25. The tube rack of clause 24, wherein the biological samples comprise at least one of blood, plasma, cerebrospinal fluid, sputum, stool, urine, lymphatic fluid, or saliva.

26. The tube rack of any of clauses 5 to 25, wherein the removable tubes comprise lysis tubes.

27. The tube rack of clause 26, wherein the removable tubes comprise non-filtered lysis tubes.

28. The tube rack of clause 26, wherein the removable tubes comprise filtered lysis tubes.

29. The tube rack of clause 28, wherein the base, the lid, and the connector comprise cold-resistant plastic.

30. A method, comprising: inserting a first set of tubes, containing a first set of biological samples, into first base holes defined by a first tube rack, the first tube rack comprising: a first planar base defining the first base holes; and a first planar lid selectively coupled to the first planar base in a connected configuration in which the first planar base extends substantially parallel to the first planar lid and a top surface of the first planar base is separated from a bottom surface of the first planar lid by a first gap, wherein tops of the first set of tubes are positioned within the first gap between the top surface of the first planar base and the bottom surface of the first planar lid, the first set of tubes extend through the first base holes, and bottoms of the first set of tubes are positioned below a bottom surface of the first planar base; inserting a second set of tubes, containing a second set of biological samples, into second base holes defined by a second tube rack, the second tube rack comprising: a second planar base defining the second base holes; and a second planar lid selectively coupled to the second planar base in the connected configuration in which the second planar base extends substantially parallel to the second planar lid and a top surface of the second planar base is separated from a bottom surface of the second planar lid by a second gap, wherein tops of the second set of tubes are positioned within the second gap between the top surface of the second planar base and the bottom surface of the second planar lid, the second set of tubes extend through the second base holes, and bottoms of the second set of tubes are positioned below a bottom surface of the second planar base; placing the first tube rack, holding the first set of tubes, into an outer container, wherein the bottoms of the first set of tubes that extend below the bottom surface of the first planar base rest on a floor of the outer container; and stacking the second tube rack, holding the second set of tubes, on top of the first tube rack within the outer container, wherein the bottoms of the second set of tubes that extend below the bottom surface of the second planar base rest on the first planar lid of the first tube rack.

31. The method of clause 30, wherein lengths and widths of the first tube rack and the second tube rack correspond to lengths and widths of an interior space of the outer container.

32. The method of clause 31, wherein the outer container is a shipping box.

33. The method of clause 31, wherein the outer container is an insulated cooler.

34. The method of any of clauses 30 to 33, wherein: the first base holes comprise a first set of forty-eight base holes, and the second base holes comprise a second set of forty-eight base holes.

35. The method of any of clauses 30 to 34, wherein: the second planar lid defines at least one of a finger hold indentation at an edge of the second planar lid or one or more lid holes, and the method further comprises removing the second tube rack from the outer container by: grasping at least one of the finger hold indentation or the one or more lid holes with one or more fingers of a user; and raising, by the user, the second tube rack vertically out of the outer container.

36. The method of any of clauses 30 to 35, wherein the first set of biological samples and the second set of biological samples are associated with one or more subjects.

37. The method of any of clauses 30 to 36, wherein the first set of biological samples and the second set of biological samples comprise at least one of blood, plasma, cerebrospinal fluid, sputum, stool, urine, lymphatic fluid, or saliva.

38. The method of any of clauses 30 to 37, wherein the first set of tubes and the second set of tubes comprise lysis tubes.

### CONCLUSION

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e., denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the,” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventor expects skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A tube rack, comprising:
a substantially planar base having a top surface and a bottom surface opposite the top surface, and defining a plurality of base holes extending from the top surface to the bottom surface, the plurality of holes being configured to removably hold lysis tubes configured to store biological samples of one or more subjects, wherein at a time at which a lysis tube is inserted into a first hole of the plurality of base holes:
a cap at a top of the lysis tube is positioned above the top surface of the base,
a length of the lysis tube extends through the first hole, and
a bottom of the lysis tube is positioned below the bottom surface of the base;
a substantially planar lid having a top surface, and a bottom surface opposite the top surface of the lid; and
a connector coupled to at least one of the base or the lid, wherein the connector selectively couples the lid to the base in a connected configuration in which:
the base extends substantially parallel to the lid,
the top surface of the base faces the bottom surface of the lid,
the top surface of the base is separated from the bottom surface of the lid by a gap, and
at the time at which the lysis tube is inserted into the first hole, the cap of the lysis tube is positioned within the gap between the top surface of the base and the bottom surface of the lid.

2. The tube rack of claim 1, wherein:
the tube rack is a first tube rack, and
a second tube rack, having a second substantially planar base defining a second plurality of base holes configured to hold second lysis tubes, is stackable on the lid of the first tube rack.

3. The tube rack of claim 2, wherein lengths and widths of the first tube rack and the second tube rack correspond to lengths and widths of an interior space of an insulated shipping container, and are configured to permit the second tube rack to be stacked on the top of the lid of the first tube rack within the insulated shipping container.

4. A tube rack comprising:
a substantially planar base defining a plurality of base holes that extend through the base and are configured to hold removable tubes, wherein at a time at which a removable tube is inserted into first hole of the plurality of base holes:
a top of the removable tube is positioned above a top surface of the base,
a length of the removable tube extends through the first hole, and
a bottom of the removable tube is positioned below a bottom surface of the base;
a substantially planar lid; and
a connector coupled to at least one of the base or the lid, wherein the connector selectively couples the lid to the base in a connected configuration in which:
the base extends substantially parallel to the lid,
the top surface of the base faces a bottom surface of the lid,
the top surface of the base is separated from the bottom surface of the lid by a gap, and
at the time at which the removable tube is inserted into the first hole, the top of the removable tube is positioned within the gap between the top surface of the base and the bottom surface of the lid.

5. The tube rack of claim 4, wherein:
the tube rack is a first tube rack, and
a second tube rack, having a second substantially planar base defining a second plurality of base holes that extend through the second base and are configured to hold second removable tubes, is stackable on the lid of the first tube rack by causing a bottom surface of each of the second removable tubes, inserted into the second plurality of base holes of the second tube rack, to rest on the lid of the first tube rack.

6. The tube rack of claim 4, wherein at least one edge of the lid has a finger hold indentation.

7. The tube rack of claim 4, wherein the lid defines a plurality of lid holes and, in the connected configuration at least a subset of the plurality of lid holes vertically align, along center points, with corresponding base holes of the base.

8. The tube rack of claim 4, wherein the lid defines a plurality of lid holes, and an individual lid hole, of the plurality of lid holes, is less than a second diameter of an individual base hole, of the plurality of base holes.

9. The tube rack of claim 4, wherein the connector comprises:
a first extension protruding, from a first position proximate to a first edge of the base, above the top surface of the base; and
a second extension protruding, from a second position proximate to a second edge of the lid, below the bottom surface of the lid.

10. The tube rack of claim 9, wherein the first extension and the second extension are configured to slidably interact to selectively couple the lid to the base in the connected configuration.

11. The tube rack of claim 10, wherein at least one of the first extension or the second extension comprises a lip protrusion configured to prevent the lid from sliding, relative to the base, beyond a predefined location.

12. The tube rack of claim 4, wherein:
a length and a width of the base corresponds to a length and a width of an interior space of an outer container configured to removably hold the tube rack, and
the outer container comprises at least one of a shipping box or an insulated cooler.

13. The tube rack of claim 4, wherein the removable tubes are configured to store biological samples of one or more subjects.

14. The tube rack of claim 4, wherein the removable tubes comprise lysis tubes.

15. A method, comprising:
inserting a first set of tubes, containing a first set of biological samples, into first base holes defined by a first tube rack, the first tube rack comprising:
a first planar base defining the first base holes; and
a first planar lid selectively coupled to the first planar base in a connected configuration in which the first planar base extends substantially parallel to the first planar lid and a top surface of the first planar base is separated from a bottom surface of the first planar lid by a first gap,
wherein tops of the first set of tubes are positioned within the first gap between the top surface of the first planar base and the bottom surface of the first planar lid, the first set of tubes extend through the first base holes, and bottoms of the first set of tubes are positioned below a bottom surface of the first planar base;
inserting a second set of tubes, containing a second set of biological samples, into second base holes defined by a second tube rack, the second tube rack comprising:
a second planar base defining the second base holes; and
a second planar lid selectively coupled to the second planar base in the connected configuration in which the second planar base extends substantially parallel to the second planar lid and a top surface of the second planar base is separated from a bottom surface of the second planar lid by a second gap,
wherein tops of the second set of tubes are positioned within the second gap between the top surface of the second planar base and the bottom surface of the second planar lid, the second set of tubes extend through the second base holes, and bottoms of the second set of tubes are positioned below a bottom surface of the second planar base;
placing the first tube rack, holding the first set of tubes, into an outer container, wherein the bottoms of the first set of tubes that extend below the bottom surface of the first planar base rest on a floor of the outer container; and
stacking the second tube rack, holding the second set of tubes, on top of the first tube rack within the outer container, wherein the bottoms of the second set of tubes that extend below the bottom surface of the second planar base rest on the first planar lid of the first tube rack.

16. The method of claim 15, wherein lengths and widths of the first tube rack and the second tube rack correspond to lengths and widths of an interior space of the outer container.

17. The method of claim 15, wherein:
the second planar lid defines at least one of a finger hold indentation at an edge of the second planar lid or one or more lid holes, and
the method further comprises removing the second tube rack from the outer container by:
grasping at least one of the finger hold indentation or the one or more lid holes with one or more fingers of a user; and
raising, by the user, the second tube rack vertically out of the outer container.

18. The method of claim 15, wherein the first set of biological samples and the second set of biological samples are associated with one or more subjects.

19. The method of claim 15, wherein the first set of biological samples and the second set of biological samples comprise at least one of blood, plasma, cerebrospinal fluid, sputum, stool, urine, lymphatic fluid, or saliva.

20. The method of claim 15, wherein the first set of tubes and the second set of tubes comprise lysis tubes.
